(19) United States
(12) Patent Application Publication
(10) Pub. No.: US 2007/0065690 A1
(43) Pub. Date: Mar. 22, 2007

(54) Coolant flow estimation by an electrical driven pump

(76) Inventors: Sascha Schaefer, Bad Camberg (DE); Johannes Lauer, Darmstadt (DE); Thomas Weispfenning, Ober-Ramstadt (DE); Peter Willimowski, Darmstadt (DE); Rolf Isermann, Seeheim (DE); Oliver Maier, Worms (DE)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/304,185

(22) Filed: Dec. 15, 2005

Related U.S. Application Data
(60) Provisional application No. 60/719,529, filed on Sep. 22, 2005.

(51) Int. Cl. H01M 8/04; G01F 1/00

(52) U.S. Cl. 429/22; 429/26; 73/861

(57) ABSTRACT

A thermal sub-system for a fuel cell system that uses pump characteristics to determine a required cooling fluid volume flow. An algorithm controls the speed of the pump to provide the desired volume flow of the cooling fluid for the system parameters. The algorithm determines a motor efficiency value based on a pump input power value and a pump speed value. The algorithm then determines a coefficient of power value based on the motor efficiency value, the pump input power value and the pump speed value. The algorithm then uses a look-up table to convert the coefficient of power value to a coefficient of flow value. The algorithm then calculates the volume flow based on the coefficient of flow value and the pump speed value.

### CROSS REFERENCE TO RELATED APPLICATIONS

This application claims the benefit of the priority date of U.S. Provisional Patent Application No. 60/719,529, titled Coolant Flow Estimation by an Electrical Driven Pump, filed Sep. 22, 2005.

### BACKGROUND OF THE INVENTION

1. Field of the Invention

This invention relates generally to a thermal sub-system for a fuel cell system and, more particularly, to a thermal sub-system for a fuel cell system that uses pump characteristics to determine a required cooling fluid volume flow.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work can act to operate a vehicle.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA).

Several fuel cells are typically combined in a fuel cell stack to generate the desired power. For the automotive fuel cell stack mentioned above, the stack may include two hundred or more individual cells. The fuel cell stack receives a cathode reactant gas, typically a flow of air forced through the stack by a compressor. Not all of the oxygen is consumed by the stack and some of the air is output as a cathode exhaust gas that may include liquid water and/or water vapor as a stack by-product. The fuel cell stack also receives an anode hydrogen reactant gas that flows into the anode side of the stack.

It is necessary that a fuel cell stack operate at an optimum relative humidity and temperature to provide efficient stack operation and durability. A typical stack operating temperature for automotive applications is about 80° C. The stack temperature provides the relative humidity within the fuel cells in the stack for a particular stack pressure. Excessive stack temperatures above the optimum temperature may damage fuel cell components and reduce the lifetime of the fuel cells. Also, stack temperatures below the optimum temperature reduces the stack performance. Therefore, fuel cell systems employ thermal sub-systems that control the temperature within the fuel cell stack to maintain a thermal equilibrium.

A typical thermal sub-system for an automotive fuel cell stack includes a radiator, a fan and a pump. The pump pumps a cooling fluid, such as water and glycol mixture, through cooling fluid channels within the fuel cell stack where the cooling fluid collects the stack waste heat. The cooling fluid is directed through a pipe or hose from the stack to the radiator where it is cooled by ambient air either forced through the radiator from movement of the vehicle or by operation of the fan. Because of the high demand of radiator airflow to reject a large amount of waste heat to provide a relatively low operating temperature, the fan is usually powerful and the radiator is relatively large. The physical size of the radiator and the power of the fan have to be higher compared to those of an internal combustion engine of similar power rating because of the lower operating temperature of the fuel cell system and the fact that only a comparably small amount of heat is rejected through the cathode exhaust in the fuel cell system.

The fuel cell stack requires a certain cooling fluid flow rate to maintain the desired stack operating temperature. The cooling fluid flow rate has to be large enough so that the fuel cell stack does not get hot spots that could damage the cells. Various system parameters determine the cooling fluid flow rate including, but not limited to, the current density of the stack, the cooling fluid temperature, the cooling fluid viscosity, system pressure drop, valve position, etc. For a thermal sub-system employing a centrifugal flow pump, the cooling fluid flow correlates to the system pressure drop because there is no independence of pressure as in displacement pumps.

Because fuel cell systems are thermally sensitive, the cooling fluid flow typically requires a flow controller, such as a proportional-integral (PI) feedback controller, well known to those skilled in the art. Feedback controllers typically require a proportionally controllable pump. Because the pressure is unknown, the actual cooling fluid flow is necessary for the flow controller.

Currently, flow sensors are used to measure the flow rate of the cooling fluid in the coolant loop, and a suitable algorithm is employed to compare the measured flow rate to the desired flow rate for the particular operating parameters of the fuel cell system. However, flow sensors used for this purpose are typically not reliable. Further, these flow sensors are large, heavy and costly. It is desirable to eliminate the flow sensor from the thermal sub-system of a fuel cell system.

### SUMMARY OF THE INVENTION

In accordance with the teachings of the present invention, a thermal sub-system for a fuel cell system is disclosed that uses pump characteristics to determine a required cooling fluid volume flow. The thermal sub-system includes a pump that pumps the cooling fluid through a coolant loop and a fuel cell stack in the system. A controller employs an algorithm that controls the speed of the pump to provide the desired volume flow of the cooling fluid for the particular system parameters. The algorithm determines a motor efficiency value based on a pump input power value and a pump speed value. The algorithm then determines a coefficient of power value based on the motor efficiency value, the pump input power value and the pump speed value. The algorithm then converts the coefficient of power value to a coefficient of flow value. The algorithm then calculates the volume flow of the cooling fluid based on the coefficient of flow value and the pump speed value.

Additional features of the present invention will become apparent from the following description and appended claims, taken in conjunction with the accompanying drawings.

### BRIEF DESCRIPTION OF THE DRAWINGS

FIG. 1 is a schematic diagram of a thermal sub-system for a fuel cell system, where the thermal sub-system employs an algorithm that uses pump characteristics to determine a required cooling fluid volume flow; and

FIG. 2 is a block diagram showing the operation of the algorithm of the invention for this purpose.

### DETAILED DESCRIPTION OF THE EMBODIMENTS

The following discussion of the embodiments of the invention directed to a thermal sub-system for a fuel cell system, where the thermal sub-system uses pump characteristics to determine a required cooling fluid volume flow for a cooling fluid is merely exemplary in nature, and is in no way intended to limit the invention or its application or uses.

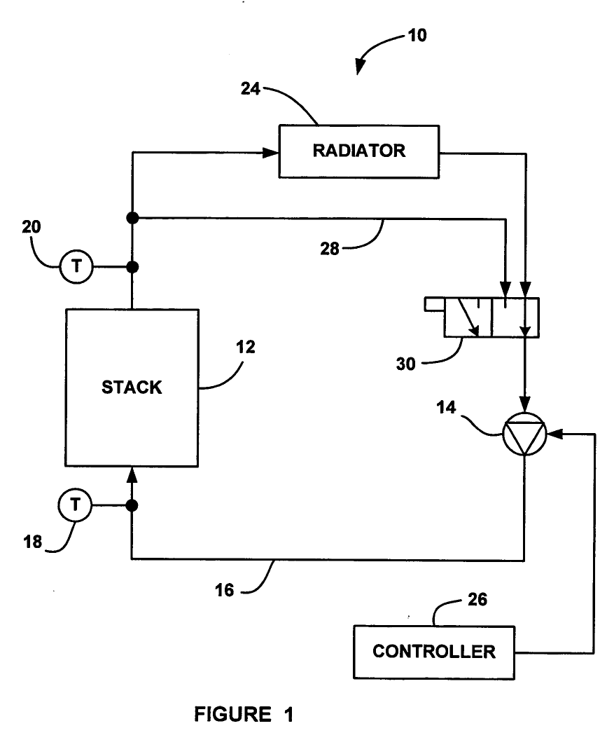

FIG. 1 is a schematic diagram of a thermal sub-system for a fuel cell system 10 including a fuel cell stack 12. A coolant loop pump 14 pumps a suitable cooling fluid, such as a water/glycol mixture, through a coolant loop 16 and the stack 12. As will be discussed in detail below, a controller 26 controls the pump 14, where the controller 26 employs an algorithm that uses pump characteristics only to determine the cooling fluid volume flow of the cooling fluid flow through the loop 16 for the particular operating parameters of the system 10, such as stack current density.

A first temperature sensor 18 measures the temperature of the cooling fluid in the coolant loop 16 as it is being input into the stack 12 and a second temperature sensor 20 measures the temperature of the cooling fluid in the coolant loop 16 as it is being output from the stack 12. A suitable chilling device, such as a radiator 24, cools the cooling fluid in the coolant loop from the stack 12 so that it is reduced in temperature. The radiator 24 may include a fan (not shown) that forces cooling air through the radiator 12 to increase the cooling efficiency of the radiator 24. Further, other cooling devices can also be used instead of the radiator 24. A by-pass line 28 in the coolant loop 16 allows the radiator 24 to be by-passed if the operating temperature of the stack 12 is not at the desired operating temperature, such as during system start-up. A by-pass valve 30 is selectively controlled to distribute the cooling fluid through either the radiator 24 or the by-pass line 28 to help maintain a desired operating temperature. The valve 30 can be any suitable valve for this purpose that can selectively provide a certain amount of the cooling fluid to the radiator 24 and the by-pass line 28.

The volume flow of the cooling fluid in the loop 16 depends on the pump speed and the pressure drop in the coolant loop 16. By knowing the pump characteristics and the fuel cell system characteristics, the pressure can be determined. In the present invention, the volume flow of the cooling fluid is determined by the pump characteristics, but is independent from the system characteristics.

According to the invention, the algorithm that determines the cooling fluid volume flow in the coolant loop 16 uses the speed of the pump 14 and power input values based on non-dimensional characteristic parameters to describe the behavior of the pump 14. A first parameter is the coefficient of pressure defined as:

$$ψ = \frac{2 gH}{{( π {D}_{2} n )}^{2}} \qquad ( 1 )$$

Where g is gravitational acceleration in m/s², H is a delivery head or cooling fluid pressure from the pump 14 in m, D₂ is the outer diameter of the motor impeller in m, and n is the pump speed in 1/s.

A second parameter is the coefficient of flow of the cooling fluid defined as:

$$φ = \frac{4 \dot{V}}{{π}^{2} {D}_{2}^{3} n} \qquad ( 2 )$$

Where \dot{V} is the volume flow of the cooling fluid in m³/s.

A third parameter is the coefficient of power defined as:

$$λ = \frac{ψφ}{{η}_{p}} \qquad ( 3 )$$

Where ηₚ is the efficiency of the pump 14.

Equations (1) and (2) are used to determine equation (3) and the pump efficiency value ηₚ is derived from the overall efficiency η as:

$$η = {η}_{p} \cdot {η}_{mot} = \frac{{P}_{out}}{{P}_{i n}} = \frac{ρ gH \dot{V}}{UI} \qquad ( 4 )$$

Where η is the overall efficiency, ηₘₒₜ is the motor efficiency, Pₒᵤₜ is the output power (hydraulic) of the pump 14 in W, Pᵢₙ is the input power (electric) of the pump 14 in W, ρ is fluid density of the cooling fluid in kg/m³, U is the pump motor voltage, and I is the pump motor current.

From equation (4):

$$λ = \frac{8 UI {η}_{mot}}{{π}^{4} {D}_{2}^{5} ρ {n}^{3}} \qquad ( 5 )$$

The motor efficiency value ηₘₒₜ is stored in a look-up table as a function of the pump speed value n and the input power value Pᵢₙ. Equation (5) shows that the coefficient of power value λ can be determined using the pump speed value n and the input power value Pᵢₙ for the motor efficiency value ηₘₒₜ. The pump characteristic λ=f(φ) is also stored in a look-up table and is inverted to provide φ=f⁻(λ) to yield the coefficient of cooling fluid flow through the coolant loop 16.

From equation (2) the volume flow \dot{V} of the cooling fluid delivered by the pump 14 can be calculated as:

$$\dot{V} = φ \frac{{D}_{2}^{3}}{4} {π}^{2} n \qquad ( 6 )$$

The volume flow value \dot{V} can then be used in a proportional-integral-derivative (PID) controller, or other suitable controller, to compare it to the desired volume flow of the cooling fluid provided from a look-up table for the current density of the stack currently being provided. The algorithm can then change the pump speed value n so that the difference between the calculated volume flow value \dot{V} and the volume flow of the cooling fluid from the look-up table are the same. Alternately, the calculated volume flow value \dot{V} can be used as a diagnostics tool to provide a warning that the fuel cell stack 12 is not being properly cooled.

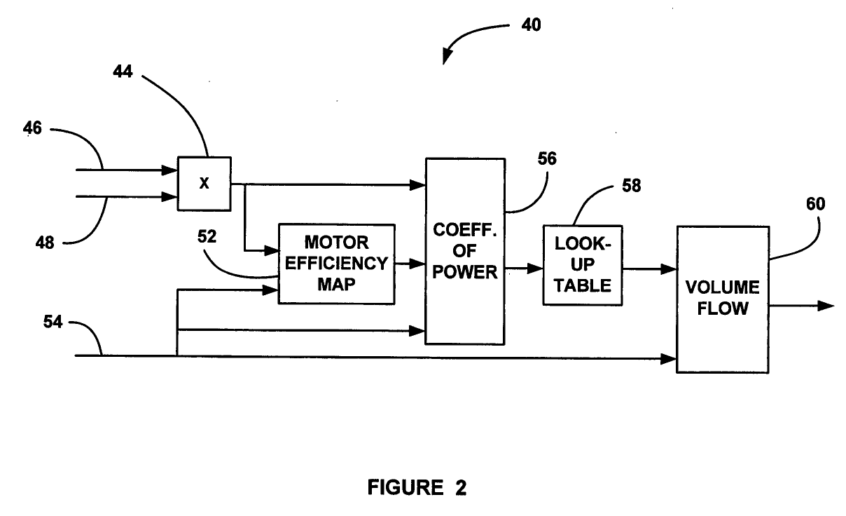

FIG. 2 is a block diagram 40 showing a process for the algorithm described above for determining the desired volume flow value \dot{V} of the cooling fluid in the loop 16. The pump motor voltage value U on line 46 and the pump motor current value I on line 48 are multiplied by a multiplier 44 to generate the input power value Pᵢₙ of the pump 14. The input power value Pᵢₙ from the multiplier 44 and the current pump speed value n on line 54 are applied to a motor efficiency map 52 that generates the motor efficiency value ηₘₒₜ. The motor efficiency map 52 describes the electrical motor characteristic between the pump speed value n and the motor power, as is well understood in the art. The input power value Pᵢₙ, the motor efficiency value ηₘₒₜ and the pump speed value n are applied to a coefficient of power processor 56 that generates the coefficient of power value λ using equation (5). The coefficient of power value λ is then used in a look-up table 58 that provides the characteristics of the pump 14 to provide the coefficient of flow value φ using equations (1)-(3). The coefficient of flow value φ and the pump speed value n are sent to a volume flow processor 60 that calculates the volume flow value \dot{V} using equation (6).

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining a volume flow of a fluid being pumped by a pump through a system, said method comprising:
determining a motor efficiency value based on an input power value of the pump and a pump speed value of the speed of the pump;
determining a coefficient of power value based on the motor efficiency value, the input power value and the pump speed value;
converting the coefficient of power value to a coefficient of flow value; and
determining the volume flow of the fluid using the coefficient of flow value and the pump speed value.

2. The method according to claim 1 further comprising calculating the input power value by multiplying a pump motor voltage and a pump motor current.

3. The method according to claim 2 wherein determining the coefficient of power value includes using the equation:
$$λ = \frac{8 UI {η}_{mot}}{{π}^{4} {D}_{2}^{5} ρ {n}^{3}}$$
where λ is the coefficient of power value, U is the pump motor voltage, I is a pump motor current, ηₘₒₜ is a motor efficiency value, D₂ is the outer diameter of an impeller of the pump, ρ is fluid density of the cooling fluid and n is the pump speed value.

4. The method according to claim 1 wherein determining the volume flow includes using the equation:
$$\dot{V} = φ \frac{{D}_{2}^{3}}{4} {π}^{2} n$$
where \dot{V} is the volume flow, φ is the coefficient of flow value, D₂ is the outer diameter of an impeller of the pump and n is the pump speed value.

5. The method according to claim 1 wherein determining the coefficient of power value includes using a motor efficiency map.

6. The method according to claim 1 wherein converting the coefficient of power value to a coefficient of flow value includes using a look-up table.

7. The method according to claim 1 where the system is a fuel cell system and the fluid is a cooling fluid pumped through a fuel cell stack in the fuel cell system.

8. The method according to claim 7 wherein the fuel cell system is on a vehicle.

9. A fuel cell system comprising:
a fuel cell stack;
a pump for pumping a cooling fluid through a coolant loop and the fuel cell stack; and
a controller for controlling the speed of the pump to control the volume flow of the cooling fluid through the coolant loop, said controller only using pump characteristics to determine the speed of the pump.

10. The system according to claim 9 wherein the controller calculates a motor efficiency value based on an input power value and a pump speed value of the speed of the pump, calculates a coefficient of power value based on the motor efficiency value, the input power value and the pump speed value, converts the coefficient of power value to a coefficient of flow value, and calculates the volume flow of the cooling fluid using the coefficient of flow value and the pump speed value.

11. The system according to claim 10 wherein the controller calculates the input power value by multiplying a pump motor voltage and a pump motor current.

12. The system according to claim 11 wherein the controller calculates the coefficient of power value using the equation:
$$λ = \frac{8 UI {η}_{mot}}{{π}^{4} {D}_{2}^{5} ρ {n}^{3}}$$
where λ is the co-efficient of power value, U is the pump motor voltage, I is a pump motor current, ηₘₒₜ is a motor efficiency value, D₂ is the outer diameter of an impeller of the pump, ρ is fluid density of the cooling fluid and n is the pump speed.

13. The system according to claim 10 wherein the controller calculates the volume flow using the equation:
$$\dot{V} = φ \frac{{D}_{2}^{3}}{4} {π}^{2} n$$
where \dot{V} is the volume flow, φ is the coefficient of flow value, D₂ is the outer diameter of an impeller of the pump and n is the pump speed value.

14. The system according to claim 10 wherein the controller calculates the coefficient of power value using a motor efficiency map.

15. The system according to claim 10 wherein the controller converts the coefficient of power value to a coefficient of flow value using a look-up table.

16. The system according to claim 10 wherein the fuel cell system is on a vehicle.

17. A fuel cell system comprising:
a fuel cell stack;
a pump for pumping a cooling fluid through a coolant loop and the fuel cell stack; and
a controller for the controlling the speed of the pump to control the volume flow of the cooling fluid through the coolant loop, said controller determining a motor efficiency value based on an input power value and a pump speed value of the speed of the pump, determining a coefficient of power value based on the motor efficiency value, the input power value and the pump speed value, converting the coefficient of power value to a coefficient of flow value, and determining the volume flow of the cooling fluid using the coefficient of flow value and the pump speed value.

18. The system according to claim 17 wherein the controller calculates the input power value by multiplying a pump motor voltage and a pump motor current.

19. The system according to claim 17 wherein the controller calculates the coefficient of power value using the equation:
$$λ = \frac{8 UI {η}_{mot}}{{π}^{4} {D}_{2}^{5} ρ {n}^{3}}$$
where λ is the coefficient of power value, U is the pump motor voltage, I is a pump motor current, ηₘₒₜ is a motor efficiency value, D₂ is the outer diameter of an impeller of the pump, ρ is fluid density of the cooling fluid and n is the pump speed.

20. The system according to claim 17 wherein the controller calculates the volume flow using the equation:
$$\dot{V} = φ \frac{{D}_{2}^{3}}{4} {π}^{2} n$$
where \dot{V} is the volume flow, φ is the coefficient of flow value, D₂ is the outer diameter of an impeller of the pump and n is the pump speed value.

21. The system according to claim 17 wherein the controller calculates the coefficient of power value using a motor efficiency map.

22. The system according to claim 17 wherein the controller converts the coefficient of power value to a coefficient of flow value using a look-up table.
